(19) United States
(12) Patent Application Publication
(10) Pub. No.: US 2009/0091462 A1
(43) Pub. Date: Apr. 9, 2009

(54) Method of restarting an electric home appliance in an energy-saving manner and system therefor

(75) Inventors: Hsin-Heng SU, Changhua County (TW); Ming-Yi TSAI, Taichung (TW); Shiun-Chih LIAO, Taichung (TW)

Correspondence Address: BACON & THOMAS, PLLC, 625 SLATERS LANE, FOURTH FLOOR, ALEXANDRIA, VA, 22314-1176, US

(73) Assignee: CHUNGHWA UNITED TELEVISION CO., LTD., Taichung (TW)

(21) Appl. No.: 11/905,775

(22) Filed: Oct. 4, 2007

(51) Int. Cl. G08B 21/00

(52) U.S. Cl. 340/635

(57) ABSTRACT

A system for restarting an electric home appliance in an energy-saving manner includes an AV output unit, which outputs a warning signal under an abnormal condition thereof and is restarted on receiving a restart signal; a first communication line for transmitting the warning signal; a second communication line for transmitting the restart signal; a supervising unit for receiving the warning signal via the first communication line and then generating the restart signal; and a transmission unit for storing the restart signal generated by the supervising unit and then transmitting the restart signal to the AV output unit via the second communication line when the latter is electrically connected to the transmission unit. The transmission unit is located between the supervising unit and the second communication line and internally provided with a dialing program for electrically connecting the transmission unit to the second communication line.

### FIELD OF THE INVENTION

The present invention relates to a system and method for restarting an electric home appliance, and more particularly to a system and method for restarting an electric home appliance in an energy-saving manner by employing a separate transmission unit to store a restart signal generated by a supervising unit and then transmit the restart signal to the electric home appliance via a phoneline network, so that computer resources at the supervising unit could be saved.

### BACKGROUND OF THE INVENTION

About the term “information appliances”, it refers to, on the one hand, some of the traditional electric home appliances, including TV set, refrigerator, and some small-sized household appliances, such as electric oven, microwave oven, percolator, etc., that have been added with new software or hardware technique to increase new applications thereof; and on the other hand, to some information products that have been improved and could be used as convenient as general household appliances. An information appliance may be associated with a computer and network to have the ability of linking to a network or being controlled via a network, so as to provide users with largely widened services. Communication media that may be adopted by information appliances include Internet, cables for cabled TV set, digital subscriber line (DSL) satellite, and microwave.

Among different information appliances, the Set Top Box is one of the best developed items. Taiwan Patent No. M306745 discloses a Set Top Box with audio/video (AV) switching interface comprising a signal receiving and transmitting unit for receiving and converting a digital AV signal into a transport stream (TS) signal and then sending out the latter; a central processing unit (CPU) connected to the signal receiving and transmitting unit for converting the TS signal into various AV signals; a data memory connected to the CPU to serve as a register for reading out or writing in data; an input unit connected to the CPU for receiving AV signals from other AV apparatus; an output unit connected to the CPU for further processing decoded AV signals to form various AV output signals; an AV switching unit connected to the CPU, the input unit, and the output unit so as to switch the VA output signals from the input unit and the output unit; and a control unit connected to the CPU and including a key pad, a remotely controlled receiver, and a remote controller. The key pad is connected to the CPU and has specific control functions. The remotely controlled receiver is connected to the CPU for receiving signals from the remote controller and sending the received signals to the CPU.

In the event the Set Top Box is in an abnormal condition, such as shut down due to overheat, a user unfamiliar with the structure of the Set Top Box would usually call a related dealer for on-site service, which inevitably requires a lot of labor, traffic, and time costs. According to statistic data from related dealers, as a matter of fact, most frequently abnormal conditions of the Set Top Box could be easily solved simply by restarting the Set top Box without the necessity of wasting a lot of money.

It is therefore a common target of related dealers to solve the above problem by developing a system and method for restarting an electric home appliance in an energy-saving manner.

### SUMMARY OF THE INVENTION

A primary object of the present invention is to provide a system for restarting an electric home appliance in an energy-saving manner that enables an AV output unit in an abnormal condition to output a warning signal, so that a restart signal may be generated and sent to the AV output unit via a separate communication line for the AV output unit to restart and remove the abnormal condition.

To achieve the above and other objects, the system according to the present invention includes an AV output unit, which outputs a warning signal under an abnormal condition thereof and is restarted on receiving a restart signal, wherein the restart signal includes a phone number message for determining a source of the restart signal; a first communication line for transmitting the warning signal output by the AV output unit; a second communication line for transmitting the restart signal to the AV output unit; a supervising unit for receiving the warning signal via the first communication line and then generating the restart signal; and a transmission unit for storing the restart signal generated by the supervising unit and then transmitting the restart signal to the AV output unit when the second communication line is electrically connected to the transmission unit. The transmission unit is located between the supervising unit and the second communication line, and is internally provided with a dialing program for electrically connecting the transmission unit to the second communication line.

Another object of the present invention is to provide a method of restarting an electric home appliance in an energy-saving manner. The method of the present invention is applicable to an AV output unit, and includes a detecting step, in which the AV output unit outputs a warning signal via a first communication line when the AV output unit is in an abnormal condition; a supervising step, in which a supervising unit receives the warning signal output in the detecting step and then generates a restart signal; a waiting for transmission step, in which the restart signal generated by the supervising unit is stored on a transmission unit, and a dialing program is enabled to electrically connect the transmission unit to a second communication line to allow the transmission unit to transmit the stored restart signal to the AV output unit via the second communication line; and a restarting step, in which a phone control unit receives the restart signal and then cuts off power supplied to the AV output unit before the AV output unit is restarted.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a framework of a system for restarting an electric home appliance in an energy-saving manner according to the present invention; and

FIG. 2 is a flowchart showing the steps included in a method of restarting an electric home appliance in an energy-saving manner according to the present invention.

### DETAILED DESCRIPTION OF THE PREFERRED EMBODIMENTS

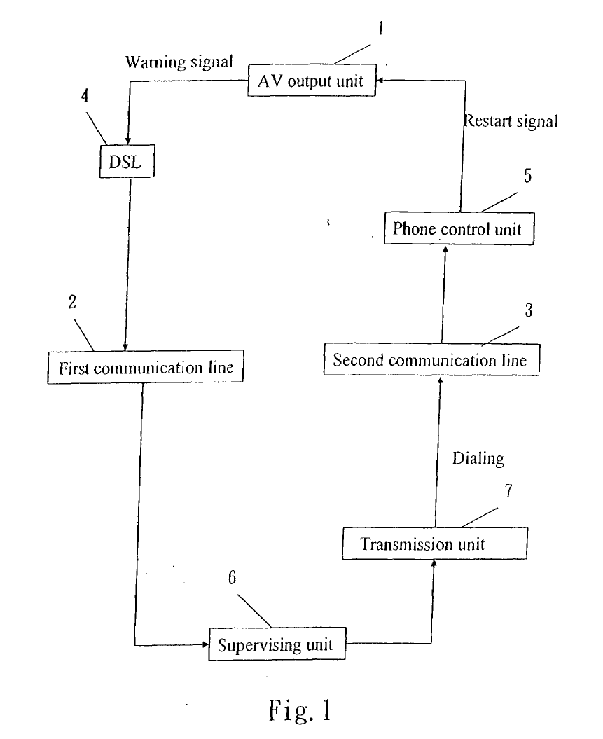

Please refer to FIG. 1, which schematically shows a framework of a system for restarting an electric home appliance in an energy-saving manner according to a preferred embodiment of the present invention. As shown, the system of the present invention includes an audio-visual (AV) output unit 1, which is able to output a warning signal under an abnormal condition thereof and to restart on receipt of a restart signal; a first communication line 2 for transmitting the warning signal output by the AV output unit 1; a second communication line 3 for transmitting the restart signal to the AV output unit 1; a digital subscriber line (DSL) communication unit 4, such as a router or a modem, provided between the AV output unit 1 and the first communication line 2; a phone control unit 5 provided between the AV output unit 1 and the second communication line 3; a supervising unit 6 for receiving the warning signal via the first communication line 2 and then generating the restart signal; and a transmission unit 7 located between the supervising unit 6 and the second communication line 3 for storing the restart signal generated by the supervising unit 6, and internally provided with a dialing program (not shown) for electrically connecting the transmission unit 7 to the second communication line 3 for transmitting the restart signal to the AV output unit 1 via the second communication line 3.

In the preferred embodiment of the present invention, the AV output unit 1 may be a digital set Top Box. The first communication line 2 is the Ethernet, and the second communication line 3 is a phoneline network.

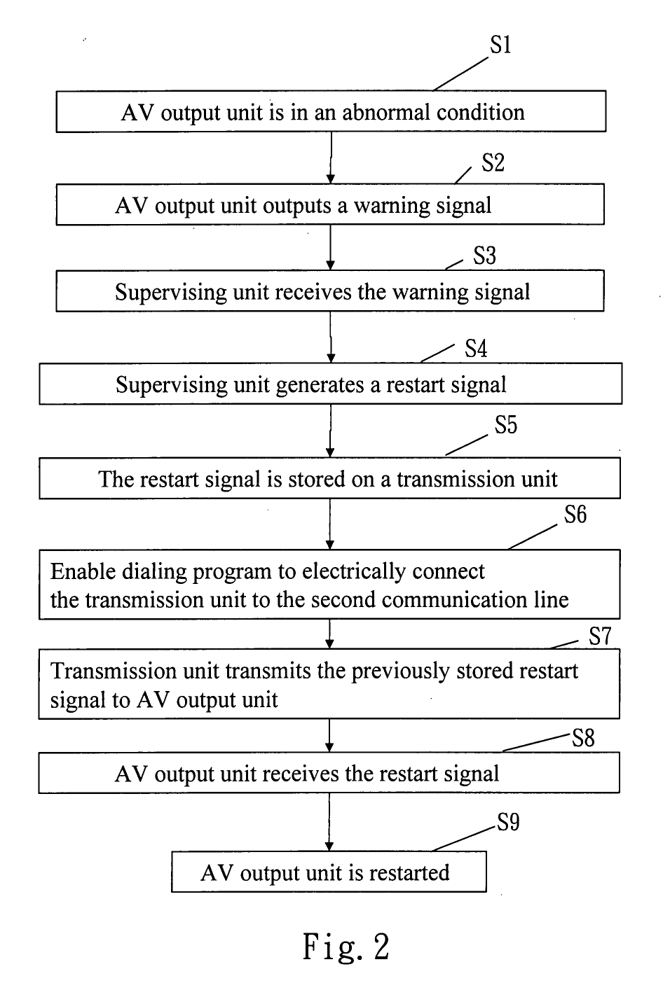

The present invention also provides a method of restarting an electric home appliance in an energy-saving manner applicable to the above-described AV output unit 1, and FIG. 2 is a flowchart showing the steps included in the method according to a preferred embodiment of the present invention. The method of the present invention includes a detecting step, a supervising step, a waiting for transmission step, and a restarting step.

In the detecting step, when the AV output unit 1 is in an abnormal condition (S1), a warning signal is output by the AV output unit 1 via the first communication line 2 (S2).

In the supervising step, the supervising unit 6 receives the warning signal output in the detecting step (S3), and generates a restart signal (S4).

In the waiting for transmission step, the restart signal generated in the supervising step is stored on the transmission unit 7 (S5), the dialing program is enabled to electrically connect the transmission unit 7 to the second communication line 3 (S6), and the transmission unit 7 transmits the restart signal previously stored thereon to the AV output unit 1 via the second communication line 3 (S7).

In the restarting step, the AV output unit 1 receives the restart signal sent out in the waiting for transmission step (S8), and is powered off and then restarted (S9).

The present invention provides the following advantages:
1. The restart signal is separately stored on the transmission unit 7, and the supervising unit 6 needs not to wait for dialing and then transmit the restart signal. Therefore, computer resources needed by the supervising unit 6 are reduced to enable saved energy consumption by the supervising unit 6 and high efficient utilization of the computer resources at the supervising unit 6.
2. When the AV output unit 1 is in an abnormal condition, the supervising unit 6 automatically generates the restart signal for the AV output unit 1 to restart automatically. Therefore, the traffic, labor, and time costs required for on-site service can be saved.
3. The use of two separate communication lines, namely, the first communication line 2 and the second communication line 3, enables the restart signal to be transmitted via the less busy second communication line 3 when the traffic over Ethernet of the first communication line 2 is heavy. Therefore, the timely transmission of the restart signal is ensured, and the second communication line 3 may be better utilized in signal transmission.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A system for restarting an electric home appliance in an energy-saving manner, comprising:
an audio-visual (AV) output unit, which is able to output a warning signal under an abnormal condition thereof and to restart on receipt of a restart signal, wherein the restart signal including a phone number message for determining a source of the restart signal;
a first communication line for transmitting the warning signal output by the AV output unit;
a second communication line for transmitting the restart signal to the AV output unit;
a supervising unit for receiving the warning signal via the first communication line and then generating the restart signal; and
a transmission unit for storing the restart signal generated by the supervising unit and then transmitting the restart signal to the AV output unit via the second communication line when the same is electrically connected to the transmission unit; and the transmission unit being located between the supervising unit and the second communication line and internally provided with a dialing program for electrically connecting the transmission unit to the second communication line.

2. The system for restarting an electric home appliance in an energy-saving manner as claimed in claim 1, wherein the AV output unit comprises a digital Set Top Box.

3. The system for restarting an electric home appliance in an energy-saving manner as claimed in claim 1, wherein the first communication line is Ethernet.

4. The system for restarting an electric home appliance in an energy-saving manner as claimed in claim 1, further comprising a digital subscriber line (DSL) communication unit provided between the AV output unit and the first communication line.

5. The system for restarting an electric home appliance in an energy-saving manner as claimed in claim 4, wherein the DSL communication unit is a router.

6. The system for restarting an electric home appliance in an energy-saving manner as claimed in claim 4, wherein the DSL communication unit is a modem.

7. The system for restarting an electric home appliance in an energy-saving manner as claimed in claim 1, wherein the second communication line is a phoneline network.

8. The system for restarting an electric home appliance in an energy-saving manner as claimed in claim 7, further comprising a phone control unit provided between the AV output unit and the second communication line for controlling electric power to the AV output unit.

9. A method of restarting an electric home appliance in an energy-saving manner, the method being applicable to an AV output unit, and comprising:
a detecting step, in which the AV output unit outputs a warning signal via a first communication line when the AV output unit is in an abnormal condition;
a supervising step, in which a supervising unit receives the warning signal output in the detecting step and then generates a restart signal;
a waiting for transmission step, in which the restart signal generated by the supervising unit is stored on a transmission unit, and a dialing program is enabled to electrically connect the transmission unit to a second communication line to allow the transmission unit to transmit the stored restart signal to the AV output unit via the second communication line; and
a restarting step, in which a phone control unit receives the restart signal and then cuts off power supplied to the AV output unit before the AV output unit is restarted.
